(19) United States
(12) Patent Application Publication
(10) Pub. No.: US 2016/0025104 A1
(43) Pub. Date: Jan. 28, 2016

(54) ANNULAR FAN WIRING STRUCTURE

(71) Applicant: Asia Vital Components Co., Ltd., New Taipei City (TW)

(72) Inventor: Ching-Hang Shen, New Taipei City (TW)

(21) Appl. No.: 14/341,858

(22) Filed: Jul. 28, 2014

(51) Int. Cl. F04D 29/52; H02K 7/14; F04D 19/00; H02K 3/38

(52) U.S. Cl. CPC F04D 29/522; H02K 3/38; H02K 7/14; F04D 19/002

(57) ABSTRACT

An annular fan wiring structure includes a frame body and at least one groove annularly formed on an outer circumference of the frame body. The groove has an open end and a closed end opposite to the open end. The open end is flush with the outer circumference of the frame body. According to the structural design of the annular fan wiring structure, the wire assembly can be securely received in the groove to facilitate storage of the annular fan. In addition, multiple annular fans can be most compactly stacked to form an annular fan module. Also, the manufacturing cost of the annular fan is lowered.

### BACKGROUND OF THE INVENTION

1. Field of the Invention

The present invention relates generally to an annular fan wiring structure, and more particularly to an annular fan wiring structure in which the wire assembly can be securely received to facilitate storage of the annular fan. In addition, with the annular fan wiring structure, multiple annular fans can be most compactly stacked to form an annular fan module. Also, with the annular fan wiring structure, the manufacturing cost of the annular fan is lowered.

2. Description of the Related Art

A conventional annular cooling fan is applied to a computer system for dissipating the heat. The annular fan is powered by an external power supply via a wire assembly secured by a wiring structure. The wiring structure is formed on a rib of the annular fan for securing and protecting the power wires. By means of the wiring structure, when the annular fan operates, the power wires are prevented from loosening to be wound into the annular fan due to vibration or wind. Moreover, when assembling the computer system, the power wires are protected from being pulled and detaching from the spot-soldering section of the motor of the annular fan.

Please refer to FIG. 1, which is a perspective view of a conventional annular fan wiring structure 1. The conventional annular fan wiring structure 1 includes a frame body 11 and a fan impeller 12. The fan impeller 12 includes a hub 121 and multiple blades 122 annularly arranged on the outer circumference of the hub 121. The frame body 11 has a receiving space 13 and multiple hook sections 15. The fan impeller 12 is received in the receiving space 13. The hook sections 15 are disposed on the outer circumference of the frame body 11 and protrude therefrom for fixing a wire assembly 14 having multiple wires. The wire assembly 14 is electrically connected to the fan impeller 12. The wire assembly 14 extends from the fan impeller 12 in the receiving space 13 to outer side of the frame body 11. The wire assembly 14 is hooked and fixed by the adjacent hook sections 15 so as to wire the annular fan.

The conventional annular fan is wired by means of the hook sections of the wiring structure. However, the hook sections can hardly securely fix the wire assembly. This is because the hook sections can only partially hook the wires. That is, the wire assembly of the annular fan is hooked and fixed by the hook sections by a small area so that it is hard to secure the entire wire assembly. Some parts of the wires that are not hooked will be exposed to the outer side of the frame body in a suspending state. Under such circumstance, the suspending wires are subject to affection (such as pulling) of external articles to lead to loosening or even detachment of the entire wire assembly. Moreover, this will cause inconvenience in storage of the annular fan.

When multiple annular fans are assembled to form an annular fan module, the hook sections of the adjacent annular fans will abut against each other so that a gap exists between the adjacent annular fans. As a result, the annular fans can be hardly compactly arranged and attached to each other, (that is, the annular fans cannot be most compactly stacked).

Furthermore, the hook sections are additionally disposed on the outer circumference of the frame body of the annular fan so that more materials are consumed in manufacturing. This leads to increase of the cost.

According to the above, the conventional annular fan wiring structure has the following shortcomings:
1. It is inconvenient and troublesome to store the annular fan.
2. The annular fans cannot be most compactly stacked to form the annular fan module.
3. The manufacturing cost is increased and manufacturing process is complicated.

### SUMMARY OF THE INVENTION

It is therefore a primary object of the present invention to provide an annular fan wiring structure in which the wire assembly can be securely and conveniently received to facilitate storage of the annular fan.

It is a further object of the present invention to provide the above annular fan wiring structure. With the annular fan wiring structure, multiple annular fans can be most compactly stacked to form an annular fan module. Also, with the annular fan wiring structure, the manufacturing cost of the annular fan is lowered.

To achieve the above and other objects, the annular fan wiring structure of the present invention includes a frame body and at least one groove annularly formed on an outer circumference of the frame body. The groove has an open end and a closed end opposite to the open end. The open end is flush with the outer circumference of the frame body. According to the structural design of the annular fan wiring structure, the wire assembly can be securely received in the groove without being exposed to outer side of the frame body in a suspending state as in the conventional annular fan wiring structure. Therefore, the storage of the annular fan is facilitated. In addition, multiple annular fans can be most compactly stacked to form an annular fan module. Also, the manufacturing cost of the annular fan is lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a conventional annular fan wiring structure;

FIG. 2A is a perspective assembled view of a first embodiment of the annular fan wiring structure of the present invention;

FIG. 2B is a sectional view of the first embodiment of the annular fan wiring structure of the present invention;

FIG. 2C is a side view of the first embodiment of the annular fan wiring structure of the present invention;

FIG. 3 is a perspective exploded view of the first embodiment of the annular fan wiring structure of the present invention;

FIG. 4 is a perspective view of the first embodiment of the annular fan wiring structure of the present invention, showing the wiring thereof;

FIG. 5A is a perspective assembled view of a second embodiment of the annular fan wiring structure of the present invention;

FIG. 5B is a perspective view of the second embodiment of the annular fan wiring structure of the present invention, showing the wiring thereof;

FIG. 5C is a sectional view of a third embodiment of the annular fan wiring structure of the present invention;

FIG. 5D is a sectional view of a fourth embodiment of the annular fan wiring structure of the present invention;

FIG. 6A is a sectional view of a fifth embodiment of the annular fan wiring structure of the present invention;

FIG. 6B is a sectional view of the fifth embodiment of the annular fan wiring structure of the present invention;

FIG. 7A is a perspective view of a sixth embodiment of the annular fan wiring structure of the present invention; and

FIG. 7B is a perspective assembled view of the sixth embodiment of the annular fan wiring structure of the present invention.

### DETAILED DESCRIPTION OF THE PREFERRED EMBODIMENTS

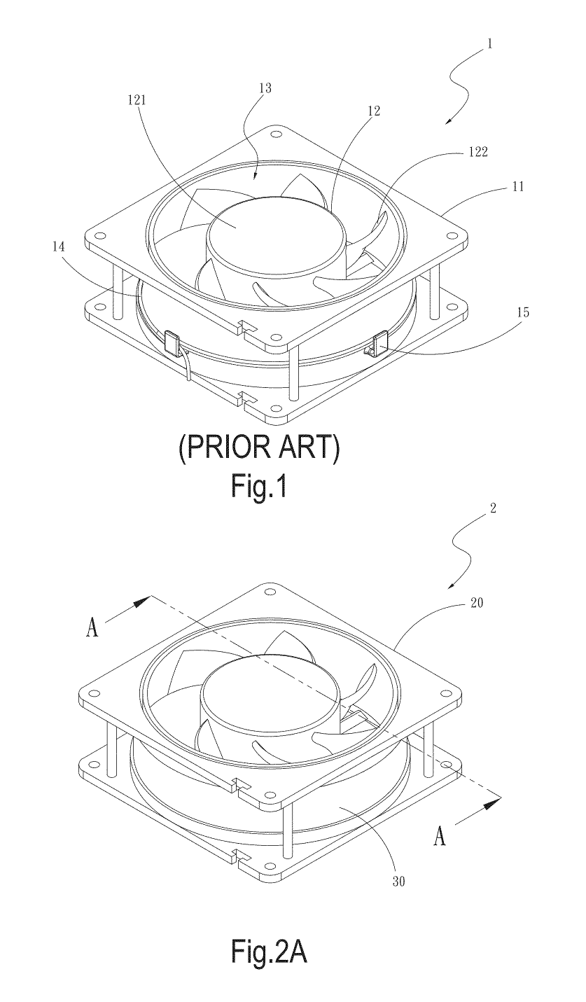

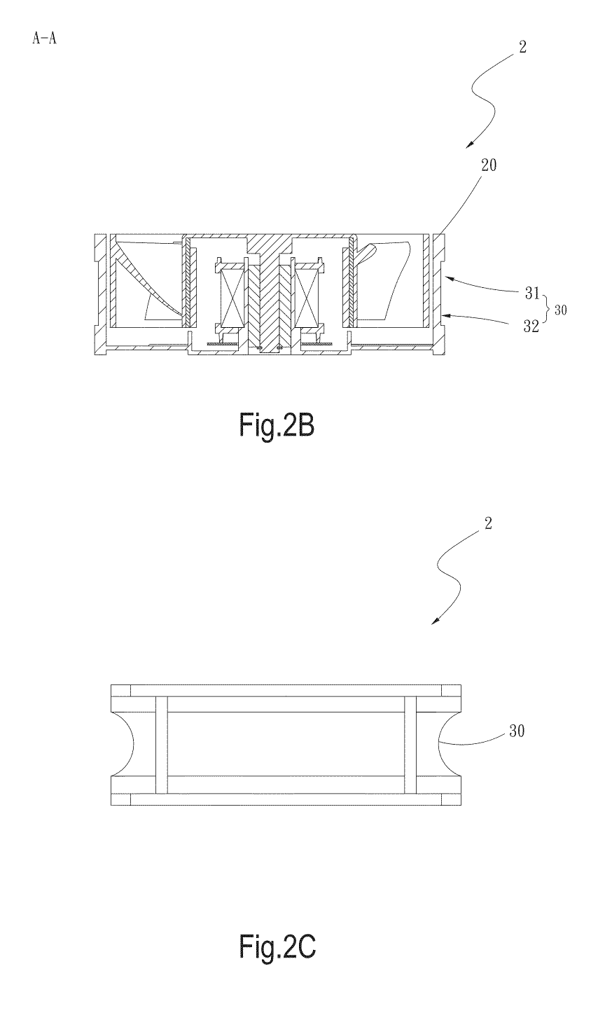

Please refer to FIGS. 2A and 2B. FIG. 2A is a perspective assembled view of a first embodiment of the annular fan wiring structure of the present invention. FIG. 2B is a sectional view of the first embodiment of the annular fan wiring structure of the present invention. According to the first embodiment, the annular fan wiring structure of the present invention includes a frame body 20 and at least one groove 30 annularly formed on an outer circumference of the frame body 20. The groove 30 has an open end 31 and a closed end 32. The open end 31 is opposite to the closed end 32 to together define the groove 30. The open end 31 is flush with the outer circumference of the frame body 20. In this embodiment, the groove 30 has a cross section, which is, but not limited to, rectangular as shown in FIG. 2B. Alternatively, the cross section of the groove 30 can be semicircular as shown in FIG. 2C.

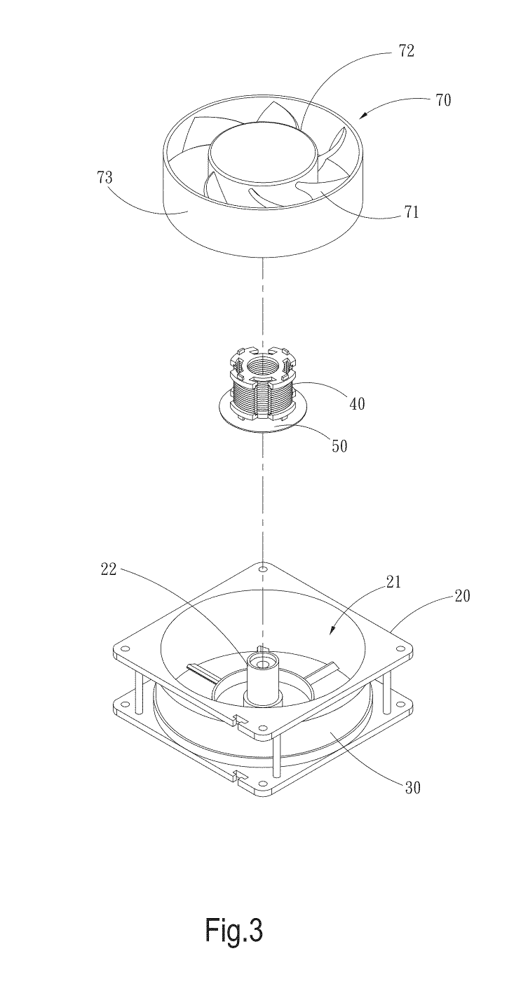

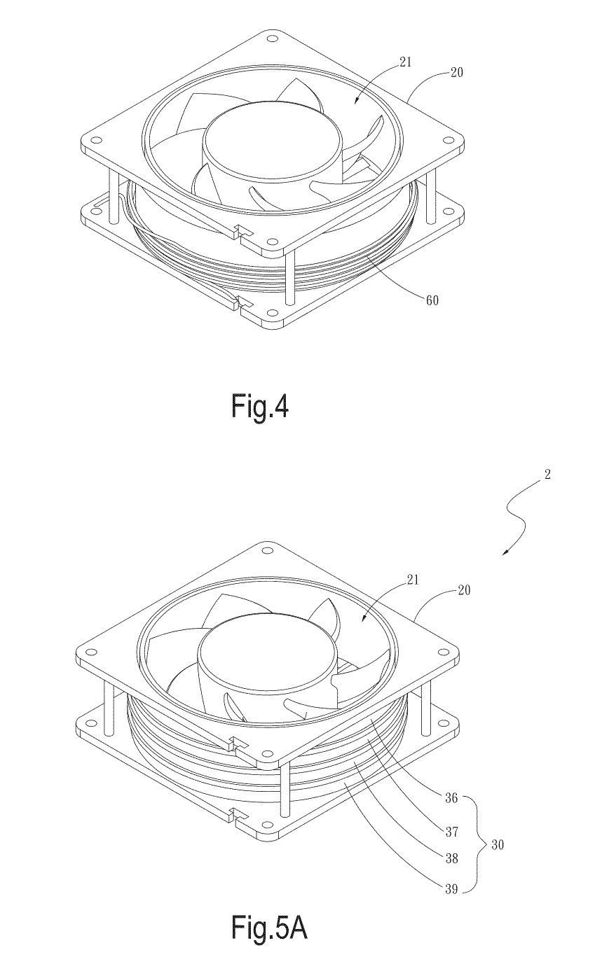

Please refer to FIGS. 3 and 4. The frame body 20 has a receiving space 21 and a bearing cup 22 disposed in the receiving space 21. A stator assembly 40 is fitted around the bearing cup 22. A fan impeller 70 is rotatably connected with the bearing cup 22, whereby the fan impeller 70 and the frame body 20 together form the annular fan 2. The fan impeller 70 is received in the receiving space 21. The fan impeller 70 includes multiple blades 71, a hub 72 and an annular body 73. The blades 71 are annularly arranged on an outer circumference of the hub 72. The annular body 73 is positioned around the blades 71.

In addition, a circuit board 50 is mated with one side of the stator assembly 40 and electrically connected to the stator assembly 40 and a wire assembly 60. The wire assembly 60 includes multiple wires extending out from the receiving space 21 to be wound along the corresponding groove 30. That is, one end of the wire is electrically connected to the circuit board 50, while the other end of the wire extends from the receiving space 21 to outer side of the frame body 20 to be wound along the groove 30 formed on the outer circumference of the frame body 20. Accordingly, the wires are securely received in the groove 30 without being exposed to outer side of the frame body 20 in a suspending state. In this case, the annular fan can be conveniently stored without randomness of the wires as in the conventional annular fan.

The outer circumference of the frame body 20 of the present invention is formed with the groove 30 in which the wire assembly 60 can be securely received. Accordingly, the annular fan can be easily wired and conveniently stored. Moreover, in manufacturing, the groove 30 is integrally formed on the outer circumference of the frame body 20 so that the consumption of the material is reduced and the manufacturing cost is lowered.

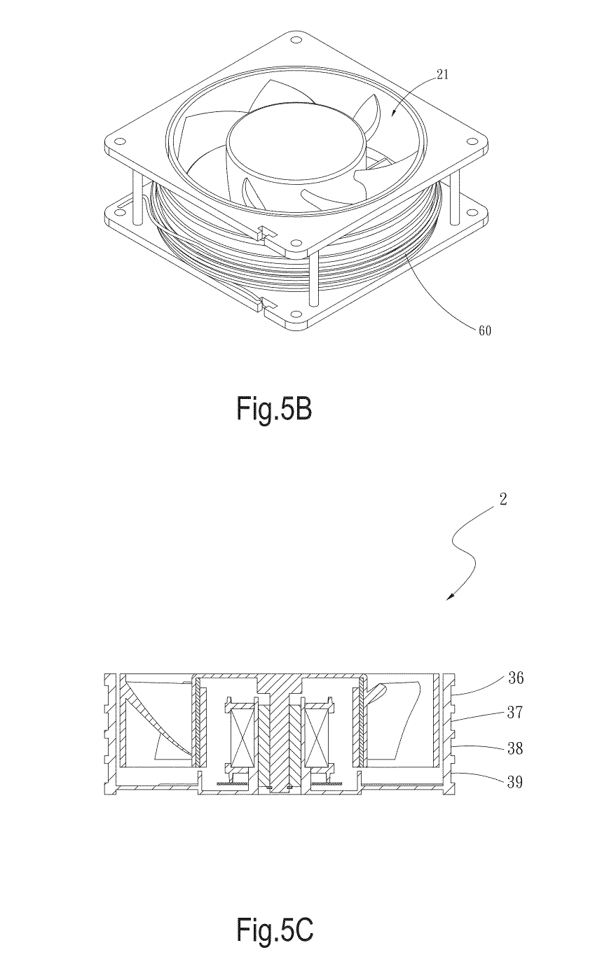

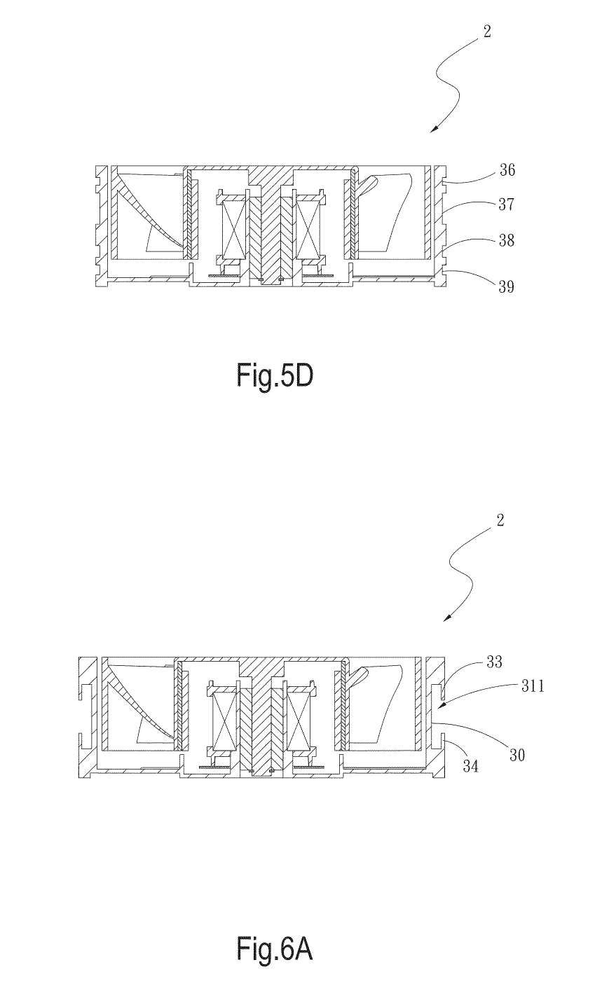

Please now refer to FIGS. 5A and 5B. FIG. 5A is a perspective assembled view of a second embodiment of the annular fan wiring structure of the present invention. FIG. 5B is a perspective view of the second embodiment of the annular fan wiring structure of the present invention, showing the wiring thereof. The second embodiment is substantially identical to the first embodiment in structure, connection relationship and effect and thus will not be repeatedly described hereinafter. The second embodiment is different from the first embodiment in that the groove 30 includes a first groove 36, a second groove 37, a third groove 38 and a fourth groove 39. The first to fourth grooves 36, 37, 38, 39 are annularly formed on the outer circumference of the frame body 20. Accordingly, not only the wire assembly 60 can be securely received in the first to fourth grooves 36, 37, 38, 39 to facilitate storage of the annular fan, but also different kinds of wires can be classified and received in different grooves.

Furthermore, the first to fourth grooves 36, 37, 38, 39 can be arranged at equal intervals (third embodiment as shown in FIG. 5C) or arranged at unequal intervals (fourth embodiment as shown in FIG. 5D).

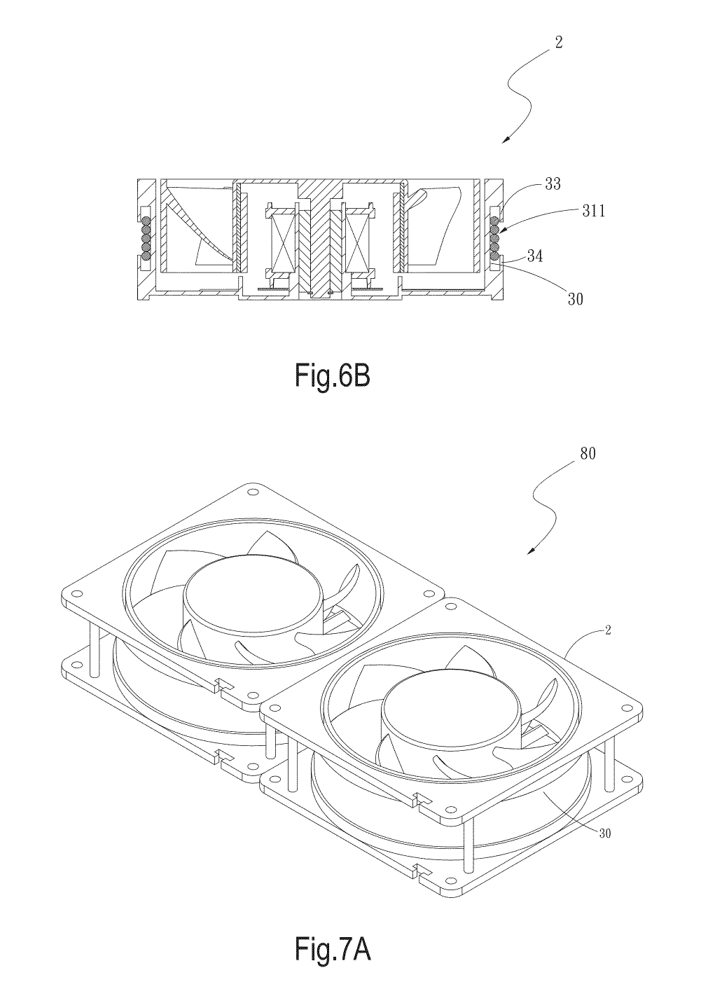

Please now refer to FIGS. 6A and 6B. FIG. 6A is a sectional view of a fifth embodiment of the annular fan wiring structure of the present invention. FIG. 6B is a sectional view of the fifth embodiment of the annular fan wiring structure of the present invention. The fifth embodiment is substantially identical to the first embodiment in structure, connection relationship and effect and thus will not be repeatedly described hereinafter. The fifth embodiment is different from the first embodiment in that at least one first protrusion 33 and at least one second protrusion 34 opposite to the first protrusion 33 are respectively formed on two opposite inner walls of the groove 30. The first and second protrusions 33, 34 respectively protrude from the two opposite inner walls of the groove 30 toward a center of the groove 30 in adjacency to the open end of the groove 30. The first and second protrusions 33, 34 serve to help in securing the wire assembly 60 in the groove 30.

The first and second protrusions 33, 34 together define an opening 311 in communication with the groove 30.

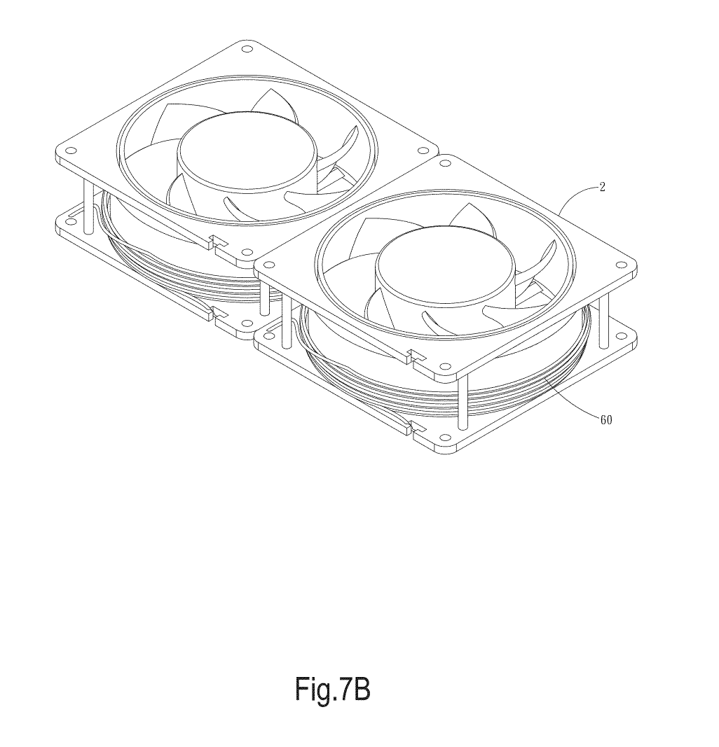

Please now refer to FIGS. 7A and 7B. FIG. 7A is a perspective view of a sixth embodiment of the annular fan wiring structure of the present invention. FIG. 7B is a perspective assembled view of the sixth embodiment of the annular fan wiring structure of the present invention. In the sixth embodiment, the first embodiment of the annular fan 2 with the wiring structure is applied to an annular fan module 80 for illustration purposes. Similarly, the second and third embodiments of the annular fan can be also applied to the annular fan module 80 to achieve the same effect.

The annular fan module 80 includes multiple annular fans 2, which are substantially identical to the first embodiment of the annular fan 2 with the wiring structure in structure, connection relationship and effect and thus will not be repeatedly described hereinafter. When it is desired to assemble multiple annular fans 2 into the annular fan module 80, the wire assemblies 60 of the annular fans 2 are first securely received in the grooves 30 and then the annular fans 2 are tightly attached to and combined with each other. In this case, the annular fans 2 can be most compactly stacked with the wires securely received in the grooves to facilitate the storage and save cost.

In conclusion, in comparison with the conventional annular fan wiring structure, the present invention has the following advantages:
1. The wire assembly can be securely received in the groove to facilitate storage of the annular fan.
2. Multiple annular fans can be most compactly stacked to form the annular fan module.
3. The cost is saved.

The present invention has been described with the above embodiments thereof and it is understood that many changes and modifications in the above embodiments can be carried out without departing from the scope and the spirit of the invention that is intended to be limited only by the appended claims.

What is claimed is:

1. An annular fan wiring structure comprising a frame body and at least one groove annularly formed on an outer circumference of the frame body, the groove having an open end and a closed end opposite to the open end, the open end being flush with the outer circumference of the frame body.

2. The annular fan wiring structure as claimed in claim 1, wherein at least one first protrusion and at least one second protrusion opposite to the first protrusion are respectively formed on two opposite inner walls of the groove, the first and second protrusions respectively protruding from the two opposite inner walls of the groove toward a center of the groove in adjacency to the open end of the groove.

3. The annular fan wiring structure as claimed in claim 2, wherein the first and second protrusions 33, 34 together define an opening in communication with the groove.

4. The annular fan wiring structure as claimed in claim 1, wherein the groove includes a first groove, a second groove, a third groove and a fourth groove, the first to fourth grooves being annularly formed on the outer circumference of the frame body.

5. The annular fan wiring structure as claimed in claim 4, wherein the first to fourth grooves are arranged at equal intervals.

6. The annular fan wiring structure as claimed in claim 4, wherein the first to fourth grooves are arranged at unequal intervals.

7. The annular fan wiring structure as claimed in claim 1, wherein the frame body has a receiving space and a bearing cup disposed in the receiving space, a stator assembly being fitted around the bearing cup, a circuit board being mated with one side of the stator assembly and electrically connected to the stator assembly and a wire assembly.

8. The annular fan wiring structure as claimed in claim 7, wherein the wire assembly includes multiple wires extending out from the receiving space to be wound along the corresponding groove.

9. The annular fan wiring structure as claimed in claim 7, wherein a fan impeller is rotatably connected with the bearing cup, the fan impeller being received in the receiving space, the fan impeller including multiple blades, a hub and an annular body, the blades being annularly arranged on an outer circumference of the hub, the annular body being positioned around the blades.

10. The annular fan wiring structure as claimed in claim 1, wherein the groove has a cross section, which is rectangular or semicircular.
